(19) United States
(12) Patent Application Publication
(10) Pub. No.: US 2009/0033876 A1
(43) Pub. Date: Feb. 5, 2009

(54) ILLUMINATOR AND PROJECTION DISPLAY EMPLOYING IT

(75) Inventors: Yusaku Shimaoka, Osaka (JP); Atsushi Hatakeyama, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 11/912,590

(22) PCT Filed: Jul. 25, 2006
(86) PCT No.: PCT/JP2006/314618

§ 371 Date: Oct. 25, 2007

(30) Foreign Application Priority Data
Aug. 4, 2005 (JP) 2005-226883

(51) Int. Cl. G03B 21/14; G02B 27/10

(52) U.S. Cl. 353/31; 362/231

(57) ABSTRACT

An illuminator includes a color composition prism (24) consisting of first to third prisms (21-23), a red light emitting diode (1), a blue light emitting diode (2) and a green light emitting diode (3) emitting three light beams having different spectrum intervals, a first optical thin film (31) formed on the surface of the first prism (21) opposing the second prism (22) and having a cutoff wavelength between red and green, and a second optical thin film (32) formed on the surface of the second prism (22) opposing the third prism (23) and having a cutoff wavelength between blue and green. Consequently, it is possible to provide an illuminator that can conduct a color composition in which an optical loss at the time of color composition and a color unevenness occurring on the optical thin film due to the incident angle dependency are decreased even for natural light not under a polarization control.

### TECHNICAL FIELD

The present invention relates to an illuminator and a projection display using the same.

### BACKGROUND ART

Recently, solid light sources such as a light emitting diode have been remarked as light sources for projection displays (projector) having capability of a large screen display. Such a solid light source can emit monochromatic light beams of blue, green and red with a high color purity, and realize a color reproduction range broader in comparison with a conventional mercury arc lamp. The projection display is required to have an illuminator to provide a brighter illumination in order to realize a high-quality picture even in a well-lit room. Therefore, in order to propagate a light beam emitted from a light source to an image display element more efficiently, studies have been made to decrease an optical loss in an optical system of the illuminator.

For a full-color display of an image on a screen, light beams from the solid light sources that illuminate light of three colors of blue, green and red must be subjected to a color composition by use of the optical system in the illuminator or the projection display. Examples of this color composition means are known from some Patent documents. Patent document 1 relates to a color composition means for reducing an optical loss at the time of color composition and a color unevenness occurring on an optical thin film due to an incident angle dependency, by polarization-controlling light beams from respective light sources. Patent documents 2 and 3 relate to color composition means that do not need a polarization control but can compose colors directly even in a state of natural light.

However, the problems described below occur in the illuminators and projection displays including the above-described conventional color composition means.

A color composition means as shown in FIG. 10 is called a cross-prism 421. When this color composition means is used, polarizing plates 411, 412, 413, a quarter wave plate (not shown) or the like must be applied to light sources 401, 402, 403 that emit natural light directly, in order to reduce the optical loss at the time of color composition and a color unevenness occurring on the optical thin films 431, 432 due to the incident angle dependency.

More specifically, it is possible to suppress the optical loss at the time of the color composition and the color unevenness on the optical thin films 431, 432, by controlling the polarization of each incident light beam so that the plane of polarization of light entering the cross-prism 421 differs by 90 degrees between a perpendicular light beam and a parallel light beam with respect to the emitting direction. However, this requires members for a polarization control, such as the polarizing plates 411, 412, 413, the quarter wave plate or the like. Furthermore, optical losses will occur even on the polarizing plates 411, 412, 413 and on the quarter wave plate required for aligning one polarization with the other. As a result, for the illuminator as a whole, the efficiency of light emitted from the light sources and propagated to illuminate the image display element will deteriorate.

FIG. 11 shows a color composition means that does not require a polarization control and can compose colors even for natural light having planes of polarization present at random. This type of color composition means has been used for conventional illuminator and projection display. A xenon lamp or an extra-high pressure mercury arc lamp used as a conventional light source is a white light sources having a continuous waveband (spectrum). Therefore, the color composition means has been used often as a color composition prism for composing colors of light beams from an image display element that modulates three separated colors, and has first to third prisms 521, 522, 523, and first and second optical thin films (dichroic mirrors) 531, 532. In FIG. 11, numerals 501, 502 and 503 denote respectively a blue light emitting diode, a green light emitting diode and a red light emitting diode, and numerals 511, 512, 513 denote respectively converging lenses having a lens effect of adjusting light fluxes from the light emitting diodes emitted at a wide angle to be parallel as much as possible.

This color composition prism serves to align the optical axes of the three-color light beams by using a total reflection in the first prism 521 having a surface for emitting the three-color-composed light. Therefore, in this color composition prism, a light beam from the blue light emitting diode 501, which tends to be reflected totally in the first prism 521, is color-composed with light beams from the other light sources in the first prism 521.

Such a color composition prism has been used often not only as a color composition means but also as a color separation means. When a monochromatic light beam is separated and generated from a white light source containing many light beams adjacent to ultraviolet light, a blue light beam containing many light beams adjacent to the ultraviolet light will degrade an adhesive used for bonding the prisms or for holding the prisms with a minute spacing. In order to avoid this problem, a color separation (color composition) means formed of plural prisms is designed so that a blue light beam will be propagated only in the first prism 521 where the three-color-composed light is propagated, but the blue light will not be propagated in the other prisms.

FIG. 12 shows a color composition means that does not require a polarization control and can compose colors even for natural light having planes of polarization present at random, and in which optical thin films are formed not on prisms but on optical filters. In the thus configured color composition means, a color composition has been conducted often by inclining a first optical filter 621 having a first optical thin film (dichroic mirror) and a second optical filter 622 having a second optical thin film (dichroic mirror) by 45 degrees with respect to the optical axis as shown in FIG. 12. In FIG. 12, numerals 601, 602, 603 denote respectively a blue light emitting diode, a red light emitting diode, and a green light emitting diode. Particularly, regarding the color arrangement, locations of the light emitting diodes will not cause a considerable difference. Numerals 611, 612 and 613 denote converging lenses respectively.

A conventional light source such as a xenon lamp or an extra-high pressure mercury arc lamp has a continuous spectrum. Unlike such a conventional light source, in a light source such as a light emitting diode that emits monochromatic light, spectra of light beams of three colors of blue, green and red are not arranged equally. In many cases, a blue light spectrum 101 and a green light spectrum 102 are adjacent to each other, but an interval between the green light spectrum 102 and a red light spectrum 103 is wider than the interval between the blue light spectrum 101 and the green light spectrum 102 as shown in FIG. 2.

Furthermore, since the light from the light source is not completely parallel but it often spreads, it is known that the cutoff wavelength of the optical thin film is shifted in dependence on the incident angle of light entering the optical thin film.

Patent document 1: JP 3319438

Patent document 2: JP 2004-70018 A

Patent document 3: JP 2004-302357 A

### DISCLOSURE OF INVENTION

### Problem to be Solved by the Invention

However, in the color composition prism as shown in FIG. 11, an angle (incident angle) formed by the optical axis of light entering from the light source and a normal line of a surface on which the first optical thin film 531 having a wavelength (cutoff wavelength) at which the reflectance (transmissivity) changes rapidly between blue and green (numeral 541 in FIG. 11 represents a doubled angle to the incident angle) will be increased in comparison with an angle (incident angle) formed by the optical axis of light entering from the light source and a normal line of a surface on which the second optical thin film 532 having a cutoff wavelength between green and red (numeral 542 in FIG. 11 represents a doubled angle to the incident angle). As a result, when a light source such as a light emitting diode where the interval between the blue light spectrum and the green light spectrum is relatively narrow, problems can occur. For example, due to the shift of the cutoff wavelength caused by the incident angle dependency, a part of a certain wavelength of light, among the light beams emitted from the blue light emitting diode 501 and the green light emitting diode 502, is not reflected by a proper surface of the optical thin film, and/or not transmitted through a proper surface. These problems result in an optical loss at the time of color composition and increase the color unevenness on the optical thin films.

Similar problems have been found regarding a color composition means that includes two optical filters 621, 622 as shown in FIG. 12.

As mentioned above, in an illuminator that includes a light source such as a light emitting diode for emitting monochromatic light and in which the spectra of light of three colors of blue, green and red are not arranged equally, it has been difficult to compose colors of light beams emitted as natural light not under a polarization control, and in a condition of suppressing an optical loss at the time of the color composition and a color unevenness occurring on the optical thin film due to the incident angle dependency.

The present invention is to solve the above-mentioned problem in the conventional techniques, and it is an object of the present invention to provide an illuminator that can conduct a color composition in which an optical loss at the time of color composition and a color unevenness occurring on the optical thin film due to the incident angle dependency are decreased even for natural light not under a polarization control, and a projection display using the illuminator.

### Means for Solving Problem

For achieving the above-mentioned object, an illuminator according to the present invention includes a first light source for emitting a first color light beam, a second light source for emitting a second color light beam, a third light source for emitting a third color light beam, a first optical thin film for composing the first color light beam with a color-composed light beam of the second color light beam and the third color light beam, and a second optical thin film for composing the second color light beam and the third color light beam. Spectra of the first to third color light beams are aligned with varied spectral intervals. An incident angle of the first color light beam entering the first optical thin film differs from an incident angle of the second color light entering the second optical thin film. A cutoff wavelength of the optical thin film in which light enters at a larger incident angle is set between spectra of two color light beams having a relatively wide spectral interval.

It is preferable in the configuration of the illuminator according to the present invention that the first optical thin film is provided between a first prism in which the first color light beam and also the three-color-composed light beam of the first to third color light beams are propagated, and a second prism in which the second color light beam and the composed light beam of the second and third color light beams are propagated; and the second optical thin film is provided between the second prism and a third prism in which the third color light beam is propagated alone.

It is also preferable in the configuration of the illuminator according to the present invention that the first optical thin film is formed on a first optical filter through which the color-composed light beam of the second color light beam and the third color light beam is transmitted; and the second optical thin film is formed on a second optical filter through which the third color light beam is transmitted.

It is also preferable in the configuration of the illuminator according to the present invention that the first to third color light beams are of three colors of blue, green and red.

It is also preferable in the configuration of the illuminator according to the present invention that the first to third light sources are light-emitting diodes.

The projection display according to the present invention includes an illuminator, an image display for modulating illumination from the illuminator so as to form an image, and a projector for projecting the light modulated by the image display on a screen. The illuminator of the present invention is used as the illuminator.

### EFFECTS OF THE INVENTION

According to the present invention, it is possible to provide an illuminator that can conduct a color composition in which an optical loss at the time of color composition and a color unevenness occurring on the optical thin film due to the incident angle dependency are decreased even for natural light not under a polarization control, and a projection display using the illuminator.

### BRIEF DESCRIPTION OF DRAWINGS

FIG. 1 is a schematic diagram showing an illuminator in a first embodiment of the present invention.

FIG. 2 is a graph showing an example of spectra of light beams emitted from a red light emitting diode, a blue light emitting diode, and a green light emitting diode.

FIG. 3 is a graph showing an example of spectral characteristics of a second optical thin film having a cutoff wavelength between blue and green in the first embodiment of the present invention.

FIG. 4 is a graph showing an example of spectral characteristics of a first optical thin film having a cutoff wavelength between red and green in the first embodiment of the present invention.

FIG. 5 is a graph showing another example of spectral characteristics of a second optical thin film having a cutoff wavelength between blue and green in the first embodiment of the present invention.

FIG. 6 is a schematic diagram showing an illuminator in a second embodiment of the present invention.

FIG. 7 is a schematic diagram showing an illuminator in a third embodiment of the present invention.

FIG. 8 is a schematic diagram showing a projection display in a fourth embodiment of the present invention.

FIG. 9 is a schematic diagram showing another example of a projection display in a fourth embodiment of the present invention.

FIG. 10 is a schematic diagram showing an example of a conventional illuminator.

FIG. 11 is a schematic diagram showing another example of a conventional illuminator.

FIG. 12 is a schematic diagram showing still another example of a conventional illuminator.

### DESCRIPTION OF THE INVENTION

The present invention will be described more specifically below with reference to the embodiments.

### First Embodiment

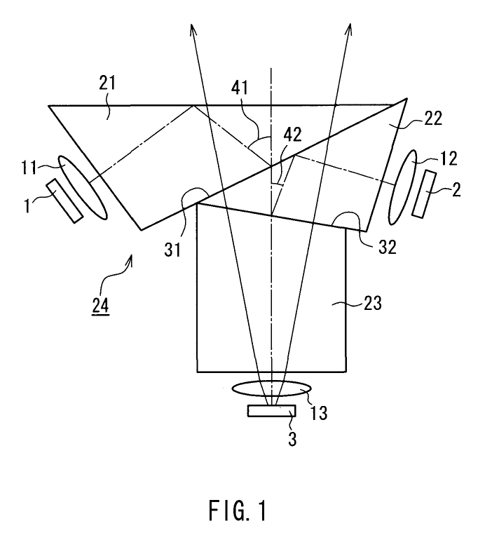

FIG. 1 is a schematic diagram showing an illuminator in a first embodiment of the present invention.

As shown in FIG. 1, the illuminator in this embodiment includes a color composition prism 24 consisting of first to third prisms 21-23, light sources arranged corresponding to the respective prisms 21-23, and converging lenses 11-13.

Here, for the light sources, red light emitting diode 1, blue light emitting diode 2 and a green light emitting diode 3 are used for emitting three light beams of different colors. The converging lenses 11-13 are optical means for converging the light beams emitted from the respective light emitting diodes 1-3 and allowing the light beams to enter the respective prisms.

The first and second prisms 21, 22 are formed as triangular prisms respectively, and the third prism 23 is formed as a trapezoidal prism. The first prism 21 has an emission surface for emitting a three-color-composed light beam. On the surface of the first prism 21 opposing the second prism 22, a first optical thin film (dichroic mirror) 31 having a cutoff wavelength between a green light spectrum and a red light spectrum is formed, and an air layer (not shown) is interposed between the first optical thin film 31 and the second prism 2. On the surface of the second prism 22 opposing the third prism 23, a second optical thin film (dichroic mirror) 32 having a cutoff wavelength between a blue light spectrum and a green light spectrum is formed, and the second optical thin film 32 and the third prism 23 are bonded to each other. The red light beam, and also a three-color-composed light beam of three colors of blue, green and red are propagated in the first prism 21; the blue light beam and a composed light beam of blue and green are propagated in the second prism 22; and the green light beam is propagated alone in the third prism 23. In this manner, the first to third prisms 21-23 are arranged from the side for emitting the three-color-composed light to the side of the green light emitting diode 3 in this order.

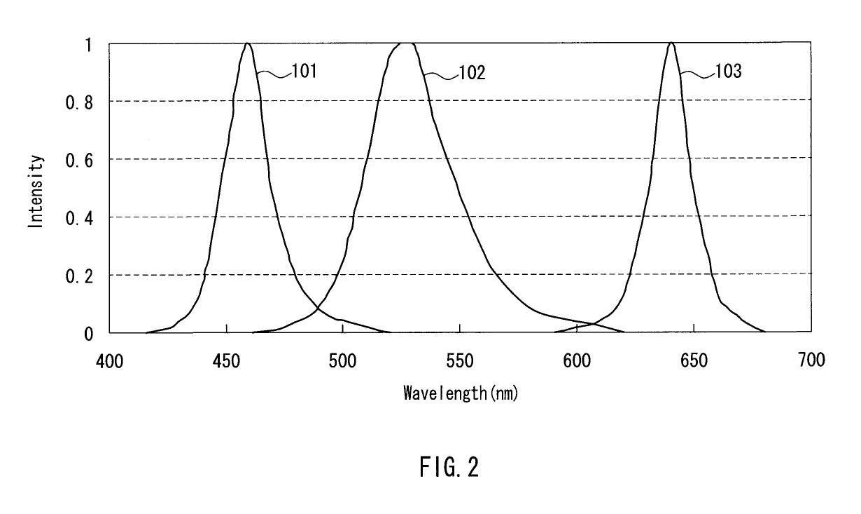

FIG. 2 shows an example of spectra of light beams emitted from the red light emitting diode 1, the blue light emitting diode 2 and the green light emitting diode 3, which are used often for a current full-color display or the like. In FIG. 2, numeral 101 denotes a spectrum of blue light emitted from the blue light emitting diode 2, numeral 102 denotes a spectrum of green light emitted from the green light emitting diode 3, and numeral 103 denotes a spectrum of red light emitted from the red light emitting diode 1. It should be noted that FIG. 2 shows normalized spectra of light for each color to have its maximum intensity as “1”, but the maximum intensities of spectra of light of the respective colors in an actual use do not coincide with each other. Namely, the relative intensity ratios of the respective color spectra change depending on the light emitting diodes or optical systems in use and the like, which are indicated in a simple manner in FIG. 2. At this time, as shown in FIG. 2, the spectra of the three-color light beams of blue, green and red emitted from the respective light emitting diodes are not arranged uniformly. Namely, the spectral interval between the blue light spectrum 101 and the green light spectrum 102 is relatively narrow, and the spectral interval between the green light spectrum 102 and the red light spectrum 103 is relatively wide.

The spectral intervals can be compared for the intervals of peak wavelengths in the spectra of the respective color light beams. Or it can be compared for the intervals of main wavelengths indicating the wavelengths of the spectral centers; or the intervals of wavelengths at intensities having certain percentages with respect to the peak intensities, for example, an interval of wavelengths at an intensity of 50% of the peak intensity, or the interval of wavelengths at an intensity of 10% of the peak intensity. The present embodiment refers to an example of an interval of wavelengths at an intensity of 50% of the peak intensity.

Next, a method of composing three colors in a case of using the above-mentioned illuminator will be described.

As shown in FIG. 1, the green light emitted from the green light emitting diode 3 enters the third prism 23 via the converging lens 13 so as to arrive at the surface on which the second optical thin film 32 is formed. The blue light emitted from the blue light emitting diode 2 enters the second prism 22 via the converging lens 12, totally reflected by the air layer formed between the first optical thin film 31 and the second prism 22, and arrives at the surface on which the second optical thin film 32 is formed.

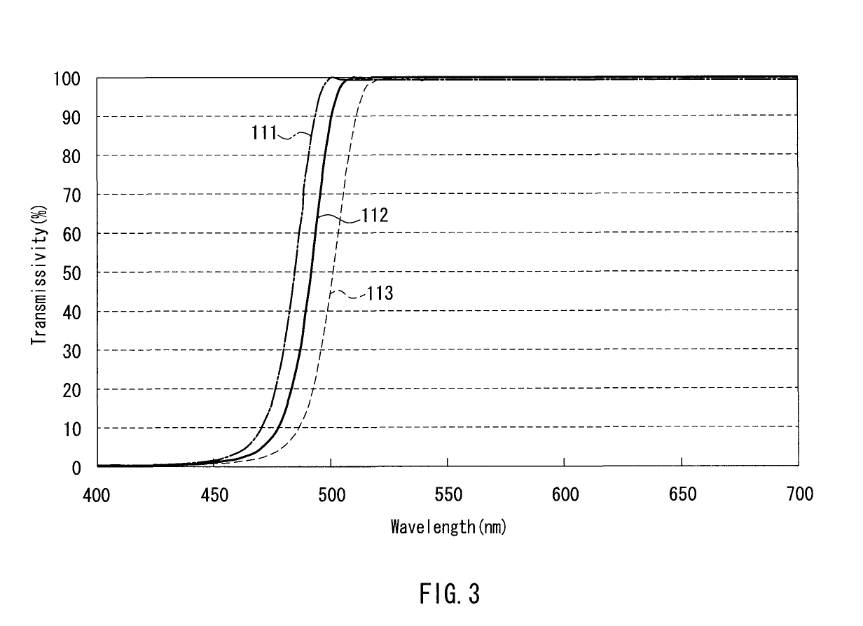

The second optical thin film 32, which is formed on the surface at which the blue light emitted from the blue light emitting diode 2 and the green light emitted from the green light emitting diode 3 arrive, has the spectral characteristics as shown in FIG. 3. In FIG. 3, a solid line 112 denotes the spectral characteristic of a light beam on the optical axis. The cutoff wavelength of the second optical thin film 32 is shifted due to the incident angle dependency of the light entering the second optical thin film 32. The broken line 113 and the dashed line 111 at the both sides of the line concerning the light beam on the optical axis denote the spectral characteristics of light beams entering at an angle of ±10 degrees with respect to the optical axis. As shown in FIG. 3, the shift amount of the cutoff wavelength of the second optical thin film 32 is about 20 nm when the incident angle of the light entering the second optical thin film 32 varies by about 10 degrees.

However, it is indicated from the spectra of the respective light beams shown in FIG. 2 that for the green light (spectrum 102) emitted from the green light emitting diode 3, a light beam having a wavelength in a range of 510 nm to 550 nm with the intensity of not lower than 50% is transmitted through the second optical thin film 32 at a high efficiency of not lower than 80% even if the incident angle varies by about 10 degrees. For the blue light (spectrum 101) emitted from the blue light emitting diode 2, the light having a wavelength of 450 nm to 470 nm as an intensity of not lower than 50% is reflected by the second optical thin film 32 at a high efficiency of not lower than 80% even if the incident angle varies by about 10 degrees. That is, light beams of most wavelengths among the light emitted from the blue light emitting diode 2 and the green light emitting diode 3 will not be lost considerably due to the second optical thin film 32. Therefore, with the second optical thin film 32, the blue light emitted from the blue light emitting diode 2 and the green light emitted from the green light emitting diode 3 can be color-composed efficiently without causing any considerable color unevenness.

Furthermore, as shown in FIG. 1, the light from the blue light emitting diode 2 and the light from the green light emitting diode 3, which have been color-composed by the second optical thin film 32, is propagated in the second prism 22 and arrives via the air layer at the surface on which the first optical thin film 31 is formed. The red light emitted from the red light emitting diode 1 enters the first prism 21 via the converging lens 11, is reflected totally by the interface between the light-emitting surface of the first prism 21 and the air, and arrives at the surface on which the first optical thin film 31 is formed.

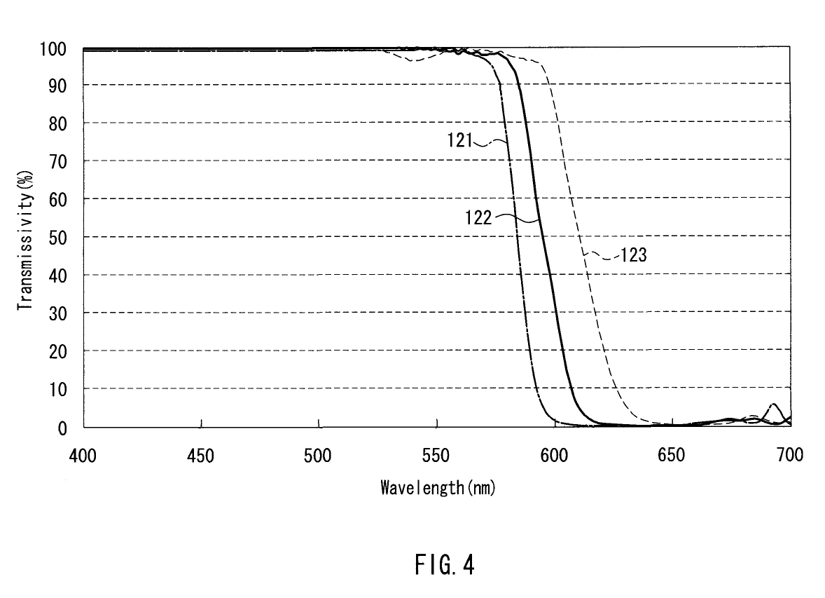

The first optical thin film 31 is formed on the surface at which the composed light including the blue light emitted from the blue light emitting diode 2 and the green light emitted from the green light emitting diode 3 and also the red light emitted from the red light emitting diode 1 arrive. The first optical thin film 31 has the spectral characteristics as shown in FIG. 4. In FIG. 4, the solid line 122 denotes the spectral characteristic of the light beam on the optical axis. The cutoff wavelength of the first optical thin film 31 is shifted due to the incident angle dependency of the light entering the first optical thin film 31. The broken line 123 and the dashed line 121 at the both sides of the line representing the light beam on the optical axis denote the spectral characteristics of light beams entering at angles of ±10 degrees with respect to the optical axis. As shown in FIG. 4, the shift amount of the cutoff wavelength of the first optical thin film 31 at the time that the incident angle of light entering the first optical thin film 31 varies by about 10 degrees is about 30 nm, which is larger by about 10 nm in comparison with a case of the second optical thin film 32.

According to FIG. 2, the blue light (spectrum 101) emitted from the blue light emitting diode 2 has a wavelength of 450 nm to 470 nm at an intensity of not lower than 50%. The green light (spectrum 102) emitted from the green light emitting diode 3 has a wavelength of 510 nm to 550 nm at an intensity of not lower than 50%. And the red light (spectrum 103) emitted from the red light emitting diode 1 has a wavelength of 630 nm to 650 nm at an intensity of not lower than 50%. The spectra of the respective light beams in FIG. 2 indicate that the spectral intervals between the green light and the red light is wider than the spectral intervals between the blue light and the green light. Therefore, even when the incident angle varies by about 10 degrees, the blue light (spectrum 101) and the green light (spectrum 102) are transmitted through the first optical thin film 31 at a high efficiency, and the red light (spectrum 103) is reflected by the first optical thin film 31 at a high efficiency. Namely, the loss is not increased due to the first optical thin film 31, for the majority of the composed light of the blue light emitted from the blue light emitting diode 2 and the green light emitted from the green light emitting diode 3, and also the red light emitted from the red light emitting diode 1. Therefore, it is possible, by using the first optical thin film 31, to compose the colors of the composed light of the blue light emitted from the blue light emitting diode 2 and the green light emitted from the green light emitting diode 3 and also the red light emitted from the red light emitting diode 1, efficiently and without causing any considerable color unevenness.

It is the most important for the above-mentioned configuration that when the angle (incident angle) formed by the optical axis of a light beam emitted from each of the light emitting diodes and the normal line of the surface on which the optical thin film is formed is increased, the shift amount of the spectral characteristics such as the cutoff wavelength will be increased even if the variation of the incident angle to the optical axis is within the substantially same range (for example, about ±10 degrees).

In the light emitting diodes used in this embodiment, the spectra of the three-color light beams of blue, green and red are not arranged uniformly. Though the blue light spectrum and the green light spectrum are adjacent to each other, the interval between the green light spectrum and the red light spectrum is wider than the interval between the blue light beam and the green light beam. Regarding the three light sources having such characteristics, the shift amount of the cutoff wavelength of the second optical thin film 32 that has the cutoff wavelength between blue and green must be decreased as much as possible. However, the shift amount of the cutoff wavelength of the first optical thin film 31 that has the cutoff wavelength between red and green can be increased a little further because the interval between the green light spectrum and the red light spectrum has more clearances than the interval between the blue light spectrum and the green light spectrum.

In the color composition prism 24 of this embodiment, the incident angle of the red light emitted from the red light emitting diode 1 onto the surface on which the first optical thin film 31 is formed (numeral 41 in FIG. 1 denotes a doubled angle of the incident angle) is larger than the incident angle of the blue light emitted from the blue light emitting diode 2 onto the surface on which the second optical thin film 32 is formed (numeral 42 in FIG. 1 denotes a doubled angle of the incident angle). As a result, an optical thin film having a cutoff wavelength between red and green whose spectral interval is wider than that between blue and green is used for the first optical thin film 31 so as to increase the incident angle dependency. An optical thin film having a cutoff wavelength between blue and green with the narrow spectral interval is used for the second optical thin film 32 so as to decrease the incident angle dependency. Thereby, the three-color composition can be obtained efficiently without causing any considerable color unevenness.

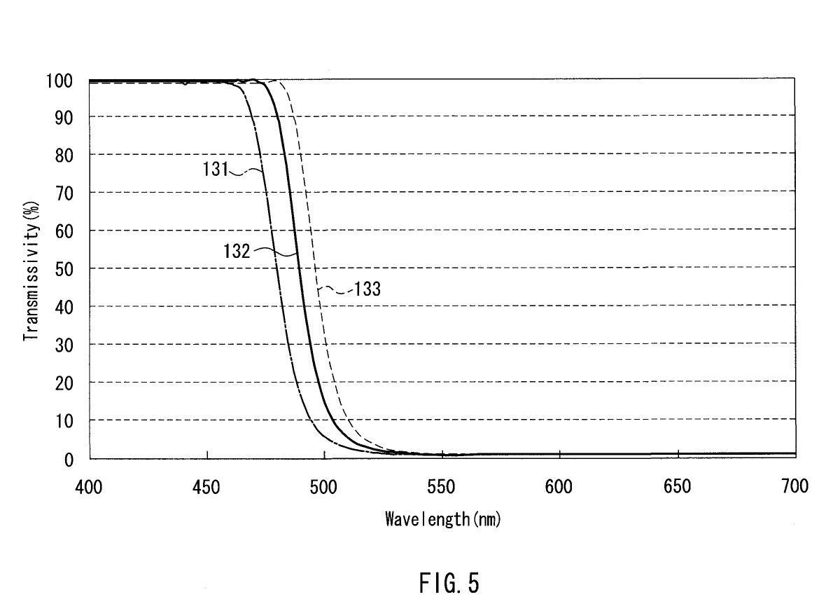

For the second optical thin film 32 of the illuminator of this embodiment as shown in FIG. 1, an optical thin film as shown in FIG. 3 is used. This film has a high transmissivity for the wavelength band at the green light side and a low transmissivity for the wavelength band at the blue light side, so that the light beam from the blue light emitting diode 2 enters from the end face of the second prism 22 and the light beam from the green light emitting diode 3 enters from the end face of the third prism 23. Alternatively, the second optical thin film 32 can be an optical thin film as shown in FIG. 5. This film has a spectral characteristic with a low transmissivity for the wavelength range at the green light side and with a high transmissivity for the wavelength range at the blue light side, so that the light beam from the blue light emitting diode 2 enters from the end face of the third prism 23, and the light beam from the green light emitting diode 3 enters from the end face of the second prism 22. That is, the color composition of the blue light and the green light with a narrow spectral interval is performed on the surface where the second optical thin film 32 is formed, and a color composition of green light and red light whose spectral interval is wider than that of the spectral interval between blue and green is performed on the surface where the first optical thin film 31 is formed. In FIG. 5, the solid line 132 denotes the spectral characteristic of a light beam on the optical axis. The broken line 133 and the dashed line 131 denote the spectral characteristics of light beams entering at ±10 degrees with respect to the optical axis.

In the illuminator of this embodiment as shown in FIG. 1, the incident angle of the red light emitted from the red light emitting diode 1 onto the surface where the first optical thin film 31 is formed (numeral 41 in FIG. 1 denotes the doubled angle of the incident angle) is larger than the incident angle of the blue light emitted from the blue light emitting diode 2 onto the surface where the second optical thin film 32 is formed (numeral 42 in FIG. 1 denotes the doubled angle of the incident angle). Therefore, for the first optical thin film 31 having a larger incident angle dependency, an optical thin film having a cutoff wavelength between red and green with a wider spectral interval than that between blue and green is used. For the second optical thin film 32 having a smaller incident angle dependency, an optical thin film having a cutoff wavelength between blue and green with a narrower spectral interval is used. In the case of a color composition prism having a configuration where the incident angle on a surface where the first optical thin film 31 is formed is smaller than the incident angle on a surface where the second optical thin film 32 is formed, the color composition of the blue light and the green light with a narrow spectral interval is performed on the surface where the first optical thin film 31 is formed, and the color composition of the green light and the red light with a spectral interval wider than that of the blue and green light is performed on the surface where the second optical thin film 32 is formed, thereby a similar effect can be obtained.

That is, irrespective of the configuration of the color composition prism, similar effects will be obtained if the following conditions are satisfied. First, the incident angle onto a surface on which the first optical thin film 31 is formed and the incident angle onto a surface on which the second optical thin film 32 is formed are compared. For the optical thin film where the light enters at a larger incident angle, an optical thin film having a cutoff wavelength between red and green is used for composing colors of a green light beam and a red light beam whose spectral interval is wider than that between blue and green. For the optical thin film where the light enters at a smaller incident angle, an optical thin film having a cutoff wavelength between blue and green is used for composing colors of a blue light beam and a green light beam whose spectral interval is narrower.

In the illuminator of this embodiment as shown in FIG. 1, for the light sources for emitting light beams of three different colors, a red light emitting diode 1, a blue light emitting diode 2 and a green light emitting diode 3 are used. However, the light sources for emitting light beams of three different colors are not limited to such light emitting diodes. For example, a monochromatic light source such as a laser light source and an organic EL element, or any other light sources emitting monochromatic light beams can be used. Alternatively, for the light beams of different three colors, a monochromatic light beam with a high color purity (narrow spectral width) separated from white light can be used. The light beams of three different colors are not limited to the three colors of blue, green and red. Light beams of three colors whose spectra are similar to each other can be used. The examples include a bluish green light beam, a green light beam and a yellowish green light beam. Namely, the light beams in use are not limited particularly as long as they have three different spectra.

Concerning the first optical thin film 31 provided on the first prism 21 and the second optical thin film 32 provided on the second prism 22, there is no particular limitation for the surface to form each of the optical thin films. There is no particular limitation as long as the first optical thin film 31 is provided between the first prism 21 and the second prism 22, and the second optical thin film 32 is provided between the second prism 22 and the third prism 23.

In the illuminator of this embodiment as shown in FIG. 1, one converging lens is arranged between each of the light emitting diodes and prisms so as to correspond to each light emitting diode. This converging lens is provided to improve the parallelism of the light flux emitted from each light emitting diode and entering the prism, but the converging lens is not an essential component. Alternatively, a plurality of converging lenses can be provided.

### Second Embodiment

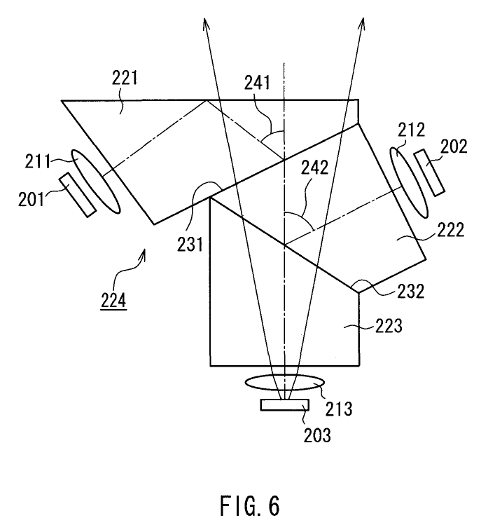

FIG. 6 is a schematic diagram showing an illuminator in a second embodiment of the present invention.

As shown in FIG. 6, the illuminator of this embodiment includes a color composition prism 224 consisting of first to third prisms 221-223, light sources arranged corresponding to the respective prisms 221-223, and converging lenses 211-213.

In this embodiment, a red light emitting diode 203, a blue light emitting diode 201 and a green light emitting diode 202 that respectively emit light beams of three different colors are used for the light sources.

The first prism 221 has a shape of a triangular prism whose apex angle part is cut off. The second and third prisms 222, 223 are formed respectively as trapezoidal prisms. The first prism 221 has an emitting surface through which a three-color-composed light beam is emitted. On the surface of the first prism 221 opposing the second prism 222, a first optical thin film (dichroic mirror) 231 having a cutoff wavelength between blue and green with a narrow spectral interval is formed. The color composition prism 24 in the first embodiment is configured such that an air layer is interposed between the first optical thin film 31 and the second prism 2 and thus the light entering the second prism 22 is reflected totally by this air layer so as to arrive at the surface where the second optical thin film 32 is formed. In the color composition prism 224 in this embodiment, there is no air layer interposed between the first prism 221 and the second prism 222, but the first optical thin film 231 and the second prism 222 are bonded to each other. And the light entering the second prism 222 arrives directly at the surface where a below-described second optical thin film 232 is formed. On the surface of the second prism 222 opposing the third prism 223, a second optical thin film (dichroic mirror) 232 having a cutoff wavelength between red and green whose spectral interval is wider than that between blue and green is formed, and the second optical thin film 232 and the third prism 223 are bonded to each other. A blue light beam and a three-color-composed light beam of blue, green and red are propagated in the first prism 221. A green light beam and a color-composed light of green and red are propagated in the second prism 222, and the red light is propagated alone in the third prism 223. In this manner, the first to third prisms 221-223 are arranged from the side of emitting the three-color-composed light to the side of the red light emitting diode 203 in this order.

In many cases, in the color composition prism 224 as shown in FIG. 6, the incident angle (numeral 241 in FIG. 6 represents a doubled angle of the incident angle) onto the surface where the first optical thin film 231 is formed is smaller than the incident angle (numeral 242 in FIG. 6 represents a doubled angle of the incident angle) onto the surface where the second optical thin film 232 is formed. In this case, for the first optical thin film 231 having a small incident angle dependency, an optical thin film having a cutoff wavelength between blue and green with a narrow spectral interval is used, and for the second optical thin film 232 having a large incident angle dependency, an optical thin film having a cutoff wavelength between red and green with a spectral interval wider than that between blue and green is used. In this manner, an effect comparable to the first embodiment can be obtained. Namely, with this configuration, it is possible to compose three colors efficiently without causing any considerable color unevenness.

Even in the case as shown in FIG. 6, sometimes the incident angle onto the surface where the first optical thin film 231 is formed becomes larger than the incident angle onto the surface where the second optical thin film 232 is formed. In such a case, for the first optical thin film 231 with a larger incident angle dependency, an optical thin film having a cutoff wavelength between red and green with a spectral interval wider than that between blue and green is used. For the second optical thin film 232 having a smaller incident angle dependency, an optical thin film having a cutoff wavelength between blue and green with a narrow spectral interval is used. Thereby, a similar effect can be obtained.

That is, irrespective of the configuration of the color composition prism, similar effects will be obtained if the following conditions are satisfied. First, the incident angle onto a surface on which the first optical thin film 231 is formed and the incident angle onto a surface on which the second optical thin film 232 is formed are compared. For the optical thin film where the light enters at a larger incident angle, an optical thin film having a cutoff wavelength between red and green is used for composing colors of a green light beam and a red light beam whose spectral interval is wider than that between blue and green. For the optical thin film where the light enters at a smaller incident angle, an optical thin film having a cutoff wavelength between blue and green is used for composing colors of a blue light beam and a green light beam whose spectral interval is narrower.

### Third Embodiment

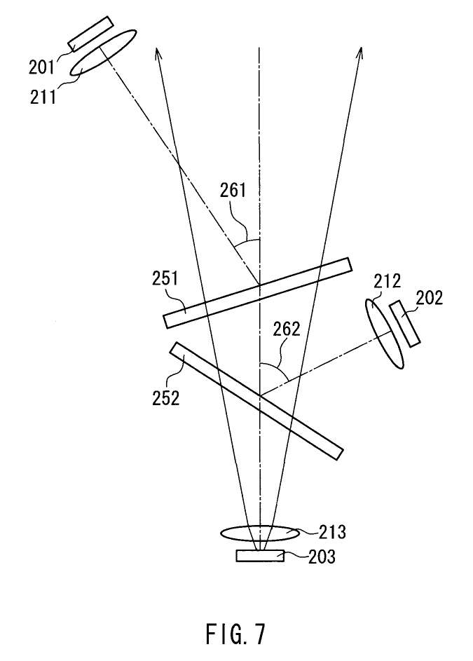

FIG. 7 is a schematic diagram showing an illuminator in a third embodiment of the present invention.

As shown in FIG. 7, the illuminator of this embodiment includes a first optical filter 251, a second optical filter 252, three light sources, and converging lenses 211-213.

In this embodiment, a red light emitting diode 203, a blue light emitting diode 201 and a green light emitting diode 202 emitting light beams of three different colors are used for the light sources.

On the first optical filter 251, a first optical thin film (dichroic mirror) having a cutoff wavelength between blue and green with a narrow spectral interval is formed. On the second optical filter 252, a second optical thin film (dichroic mirror) having a cutoff wavelength between red and green with a spectral interval wider than that between blue and green is formed. A color-composed light beam of green light and red light is transmitted through the first optical filter 251, and the blue light is reflected by the first optical thin film formed on the first optical filter 251. The red light is transmitted through the second optical filter 252, and the green light is reflected by the second optical thin film formed on the second optical filter 252.

Thereby, the green light and the red light are color-composed by the second optical filter 252, and the composed light of green and red and the blue light are color-composed by the first optical filter 251. Thereby, the three-color light beams of blue, green and red are composed.

In the configuration of the color-composition means using the two optical filters as shown in FIG. 7, the incident angle (numeral 261 in FIG. 7 represents a doubled angle of the incident angle) onto the first optical filter 251 where the first optical thin film is formed is smaller than the incident angle (numeral 262 in FIG. 7 represents a doubled angle of the incident angle) onto the second optical filter 252 where the second optical thin film is formed. In this case, for the first optical thin film with a small incident angle dependency, an optical thin film having a cutoff wavelength between blue and green with a narrow spectral interval is used. For the second optical thin film having a large incident angle dependency, an optical thin film having a cutoff wavelength between red and green with a spectral interval wider than that between blue and green is used. Thereby, an effect similar to the case of the first embodiment can be obtained. Namely, with this configuration, it is possible to compose three colors efficiently without causing any considerable color unevenness.

Even in a case as shown in FIG. 7, sometimes the incident angle onto the first optical filter 251 where the first optical thin film is formed becomes larger than the incident angle onto the second optical filter 252 where the second optical thin film is formed. In such a case, for the first optical thin film with a larger incident angle dependency, an optical thin film having a cutoff wavelength between red and green with a spectral interval wider than that between blue and green is used. For the second optical thin film having a smaller incident angle dependency, an optical thin film having a cutoff wavelength between blue and green with a narrow spectral interval is used. Thereby, a similar effect can be obtained.

In this configuration, in place of providing two optical thin films as color composition means on the side faces of the prisms, optical filters having the characteristics of the respective optical thin films are formed without using such prisms. Even with this configuration, a comparison is made for the incident angle regarding the first optical filter 251 on which the first optical thin film is formed and the incident angle regarding the second optical filter 252 on which the second optical thin film is formed. For the optical thin film where the light enters at a larger incident angle, an optical thin film having a cutoff wavelength between red and green is used for composing colors of a green light beam and a red light beam whose spectral interval is wider than that between blue and green. For the optical thin film where the light enters at a smaller incident angle, an optical thin film having a cutoff wavelength between blue and green is used for composing colors of a blue light beam and a green light beam whose spectral interval is narrower. Similar effects can be obtained when these conditions are satisfied.

### Fourth Embodiment

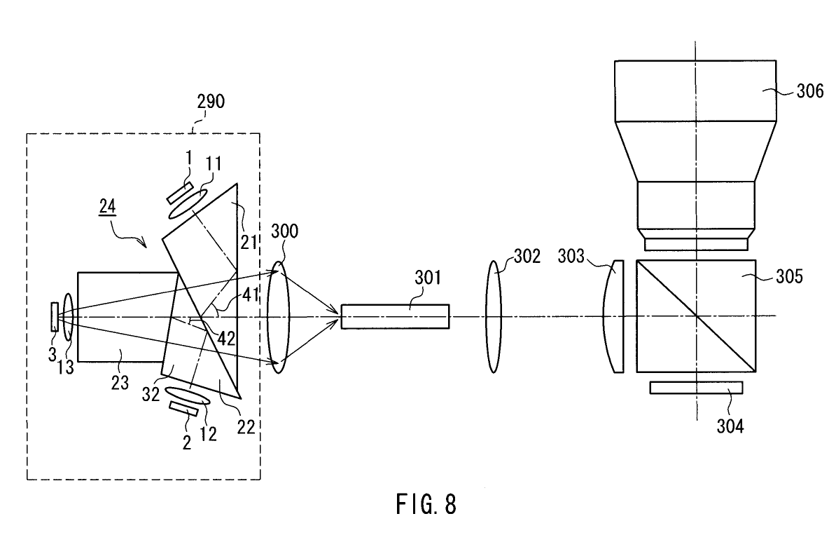

FIG. 8 is a schematic diagram showing a projection display in a fourth embodiment of the present invention.

As shown in FIG. 8, the projection display in this embodiment includes: an illuminator 290; a uniform illuminating means including a lens 300 and a rod integrator 301; an optical means including a relay lens 302 and a field lens 303; a beam splitter 305 for separating light beams of the illumination system and the projection system; an image display element 304 as an image displaying means for modulating the illumination from the illuminator 290 and forming an image; and a projection lens 306 as a projection means for projecting the light modulated by the image display element 304 on a screen (not shown). For the illuminator 290, the illuminator as shown in FIG. 1 concerning the first embodiment is used.

Hereinafter, the operations of the projection display configured as mentioned above will be described briefly.

First, three light beams having different colors emitted from the red light emitting diode 1, the blue light emitting diode 2 and the green light emitting diode 3 are composed by the illuminator 290, and emitted as a light beam on the same optical axis. The composed light emitted from the illuminator 290 is reflected by the beam splitter 305 and illuminated on the image display element 304. The image display element 304 modulates the illumination so as to form an image. In this case, the composed light emitted from the illuminator 290 is illuminated uniformly on the image display element 304 by use of the uniform illuminating means and the optical means. The light modulated by the image display element 304 is transmitted directly through the beam splitter 305 and projected on the screen by the projection lens 306. At this time, if the red light emitting diode 1, the blue light emitting diode 2 and the green light emitting diode 3 that emit light of three different colors are turned on simultaneously, the image display element 304 is irradiated with white light. When any of the light emitting diodes is turned on separately, the image display element 304 will be irradiated with each of the monochromic light beams. Thereby, the image formed by the image display element 304 is projected as a full-color picture on the screen.

In the projection display of this embodiment, since the illuminator as shown in FIG. 1 is used for the illuminator 290, a clearer image with small color unevenness can be projected on the screen.

In this embodiment, the illuminator 290 is not limited to the illuminator as shown in FIG. 1 concerning the first embodiment. For example, the other illuminators described in the first embodiment, or the illuminator as shown in FIG. 6 concerning the second embodiment can be used for the illuminator 290 in order to obtain the similar effect. A similar effect can be obtained also by using the illuminator as shown in FIG. 7 concerning the third embodiment for the illuminator 290.

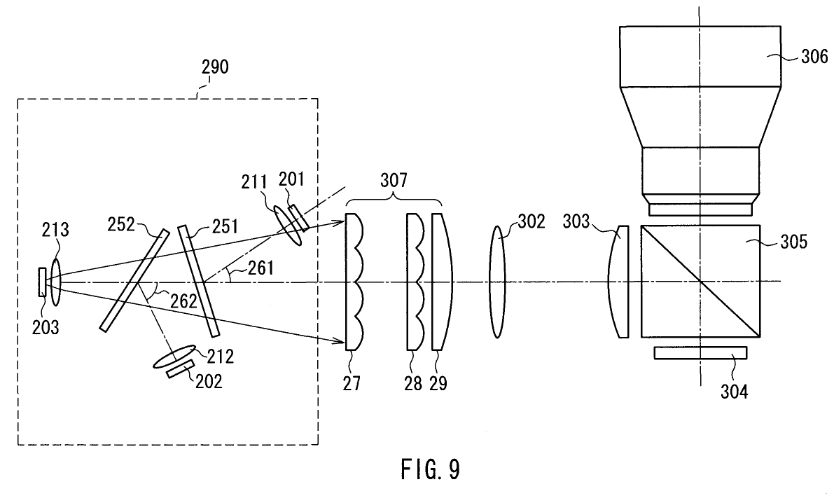

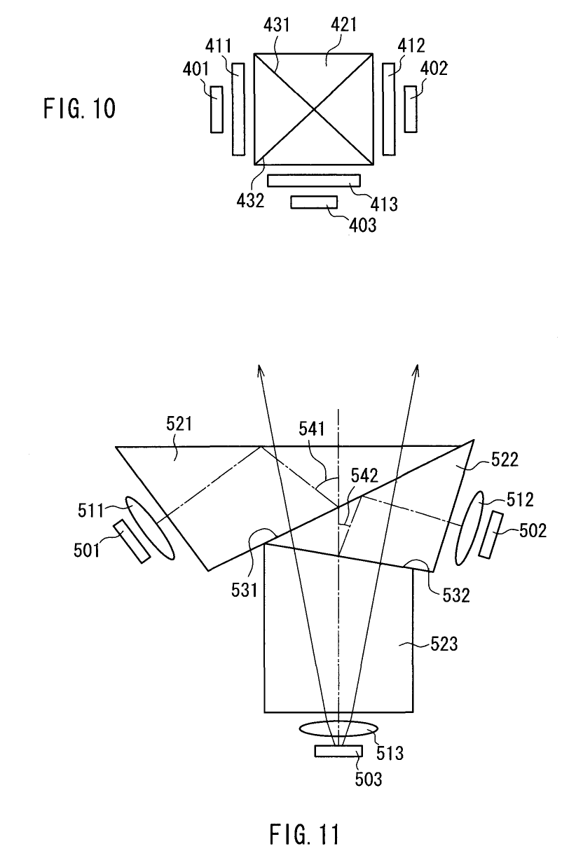

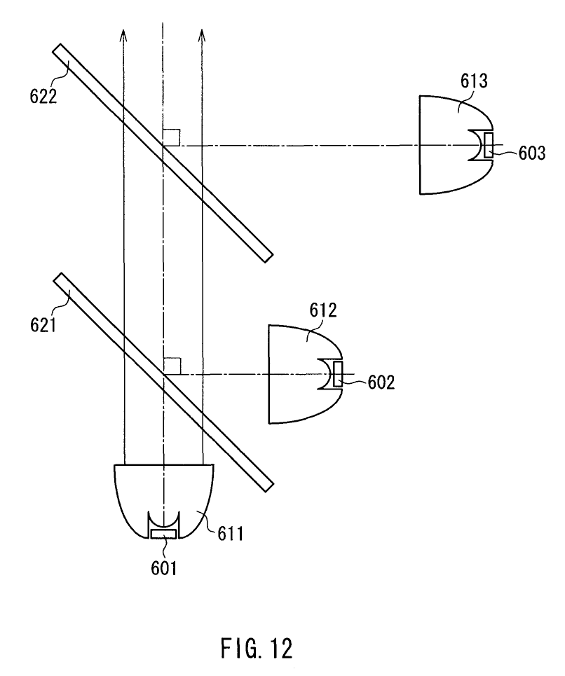

This embodiment refers to a projection display including: a uniform illuminating means including a lens 300 and a rod integrator 301; an optical means including a relay lens 302 and a field lens 303; and a beam splitter 305 for splitting light beams of the illumination system and the projection system. However, the uniform illuminating means, the optical means and the beam splitter 305 can be excluded, unless there is a specific requirement, as long as the image display element 304 is illuminated by the illuminator 290. It should be noted that, even when the lens 300 and the rod integrator 301 are replaced by an lens array type integrator 307 as shown in FIG. 9, uniform illumination similar to the case of using the lens 300 and the rod integrator 301 can be realized (in FIG. 9, an illuminator without a prism as shown in FIG. 7 is used for the illuminator 290). Here, the lens array type integrator 307 arranged in front of the illuminator 290 is formed of a first lens array 27 as a group of microlenses, a second lens array 28 corresponding each of the microlenses of the first lens array 27, and a converging lens 29. The lens array type integrator 307 splits the light emitted from the illuminator 290 into plural light beams, and illuminates the plural light beams to be superimposed on the image display element 304.

Though this embodiment refers to an example including only one image display element 304, three image display elements can be included. In such a case of including three image display elements, it is also possible to arrange each image display element between each prism and the light source in the illuminator.

### INDUSTRIAL APPLICABILITY

According to the illuminator of the present invention, it is possible to compose three different colors efficiently without causing any considerable color unevenness. Therefore, the illuminator of the present invention can be used preferably for a projector that is required to provide a clearer image with small color unevenness.

1. An illuminator comprising:
a first light source for emitting a first color light beam,
a second light source for emitting a second color light beam,
a third light source for emitting a third color light beam,
a first optical thin film for composing the first color light beam with a color-composed light beam of the second color light beam and the third color light beam, and
a second optical thin film for composing the second color light beam and the third color light beam;
wherein spectra of the first to third color light beams are aligned with varied spectral intervals,
an incident angle of the first color light beam entering the first optical thin film differs from an incident angle of the second color light entering the second optical thin film, and
a cutoff wavelength of the optical thin film in which light enters at a larger incident angle is set between spectra of two color light beams having a relatively wide spectral interval.

2. The illuminator according to claim 1, wherein the first optical thin film is provided between a first prism in which the first color light beam and also the three-color-composed light beam of the first to third color light beams are propagated, and a second prism in which the second color light beam and the composed light beam of the second and third color light beams are propagated; and
the second optical thin film is provided between the second prism and a third prism in which the third color light beam is propagated alone.

3. The illuminator according to claim 1, wherein the first optical thin film is formed on a first optical filter through which the color-composed light beam of the second color light beam and the third color light beam is transmitted; and
the second optical thin film is formed on a second optical filter through which the third color light beam is transmitted.

4. The illuminator according to claim 1, wherein the first to third color light beams are of three colors of blue, green and red.

5. The illuminator according to claim 1, wherein the first to third light sources are light-emitting diodes.

6. A projection display comprising an illuminator, an image display for modulating illumination from the illuminator so as to form an image, and a projector for projecting the light modulated by the image display on a screen,
wherein the illuminator according to claim 1 is used as the illuminator.
